(19) United States
(12) Patent Application Publication
(10) Pub. No.: US 2014/0160316 A1
(43) Pub. Date: Jun. 12, 2014

(54) MOBILE TERMINAL AND CONTROL METHOD THEREOF

(71) Applicant: LG Electronics Inc., Seoul (KR)

(72) Inventor: Jiwoon HWANG, Seoul (KR)

(73) Assignee: LG Electronics Inc., Seoul (KR)

(21) Appl. No.: 13/896,004

(22) Filed: May 16, 2013

(30) Foreign Application Priority Data
Dec. 12, 2012 (KR) 10-2012-0144032

(51) Int. Cl. H04N 1/21; G06F 17/27; H04N 5/232

(52) U.S. Cl. CPC H04N 1/2112; H04N 5/23293; G06F 17/2765
USPC 348/231.99

(57) ABSTRACT

A mobile terminal and a control method thereof are provided. The mobile terminal captures an image through a camera upon reception of a predetermined voice command and, simultaneously stores the captured image in a storage space corresponding to the voice command. Accordingly, an additional process for classifying captured images is not needed, image capture and automatic storage of a captured image in a storage space can be simultaneously performed through a single voice command.

### CROSS-REFERENCE TO RELATED APPLICATIONS

Pursuant to 35 U.S.C. §119(a), this application claims the benefit of earlier filing date and right of priority to Korean Patent Application No. 10-2012-0144032, filed on Dec. 12, 2012, the contents of which are hereby incorporated by reference herein in its entirety.

### BACKGROUND

1. Field

The present invention relates to a mobile terminal and a control method thereof, and more particularly, to a mobile terminal and a control method thereof to capture an image through a camera and efficiently manage the captured image according to a voice command.

2. Related Art

With rapid development of hardware and software technologies related to mobile terminals, mobile terminals can provide various functions or store various information and screens thereof can display various types of information.

In the case of a mobile terminal including a touchscreen, a user can access information provided through the touchscreen simply by touching the touchscreen.

### SUMMARY

Accordingly, one object of the present invention is to address the above-noted and other drawbacks of the related art.

An object of the present invention is to provide a mobile terminal and a control method thereof capable of managing an image captured through a camera more conveniently by capturing the image, storing the captured image, setting a security level at which the captured image can be accessed, sharing the captured image and setting privacy, through one voice command.

The object of the present invention can be achieved by providing a mobile terminal including a camera, a touchscreen, a speech recognition module, and a controller configured to display a preview image input through the camera on the touchscreen, to capture an image corresponding to the preview image in response to a predetermined voice command upon reception of the predetermined voice command through the speech recognition module in a speech recognition mode, and to store the captured image in a storage space corresponding to the voice command.

The controller may enter the speech recognition mode when a predetermined input is received while the preview image is displayed on the touchscreen.

The mobile terminal may further include a memory configured to map voice command types to storage spaces in which captured images will be classified and stored and to store the captured image in a corresponding storage space.

The controller may analyze the meaning of a second voice command when the second voice command similar to a first voice command stored in the memory and, when the second voice command has the same meaning as the first voice command, store the captured image in a storage space corresponding to the first voice command.

The mobile terminal may further include a wireless communication unit, wherein the controller transmits an image captured according to a predetermined voice command to at least one external device through the wireless communication unit.

The mobile terminal may further include a short range communication module, wherein the controller transmits a control signal for pairing with at least one external device corresponding to the predetermined voice command to the at least one external device and sends the captured image to the paired external device upon pairing with the at least one external device.

The controller may display, on the touchscreen, a list including a capture function and at least one voice command for storing a captured image in a predetermined storage space.

The mobile terminal may further include a location information module, wherein the controller acquires location information of the mobile terminal through the location information module and sets a security level for access of the storage space depending on the location information of the mobile terminal.

The controller may display a user interface for setting a storage space corresponding to the received voice command on the touchscreen when the voice command received in the speech recognition mode is not a predetermined voice command.

In another aspect of the present invention, provided herein is a method of controlling a mobile terminal, including: displaying a preview image input through a camera on a touchscreen; entering a speech recognition mode while the preview image is displayed on the touchscreen; receiving a predetermined voice command through a speech recognition module; capturing an image corresponding to the preview image in response to the received voice command; and storing the captured image in a storage space corresponding to the voice command.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of the present invention.

FIG. 2 is a flowchart illustrating a method of controlling a mobile terminal according to a first embodiment of the present invention.

FIGS. 3 to 10 are views for illustrating the method of controlling a mobile terminal according to the first embodiment of the present invention.

FIG. 11 is a flowchart illustrating a method of controlling a mobile terminal according to a second embodiment of the present invention.

FIGS. 12, 13 and 14 are views for illustrating the method of controlling a mobile terminal according to the second embodiment of the present invention.

FIG. 15 illustrates tagging location information to a captured image according to voice command type.

FIG. 16 illustrates an example of providing voice command types to a user when the user attempts to capture an image.

### DETAILED DESCRIPTION OF THE PREFERRED EMBODIMENTS

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smartphone, a laptop computer, a digital broadcasting terminal, personal digital assistants (PDA), a portable multimedia player (PMP), a navigation system and/or so on.

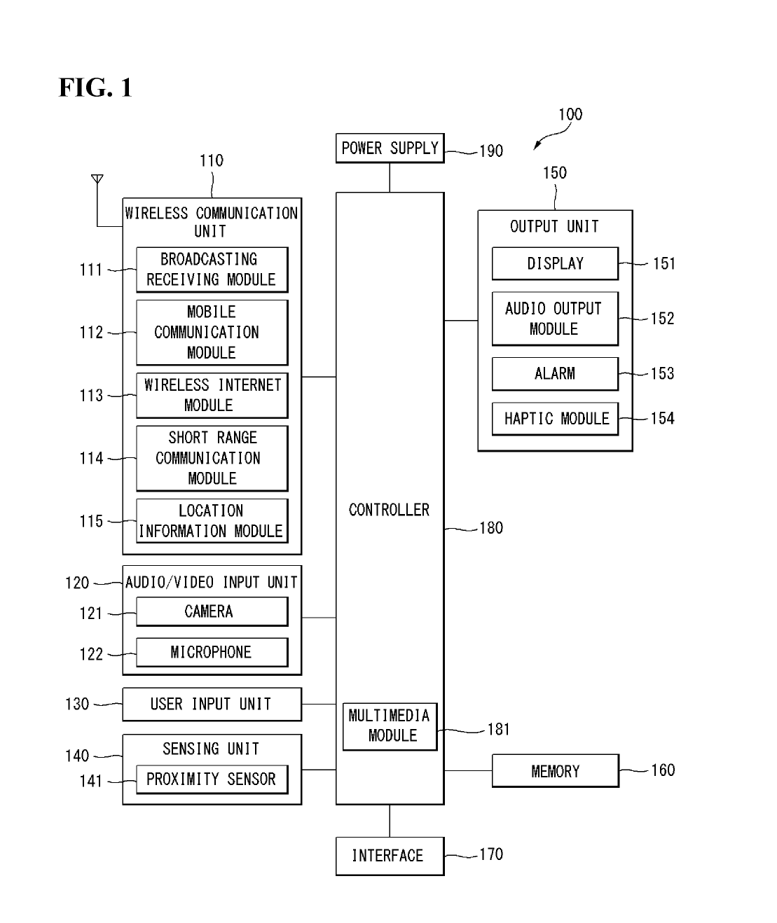

FIG. 1 is a block diagram of a mobile terminal 100 according to an embodiment of the present invention.

As shown, the mobile terminal 100 may include a wireless communication unit 110, an audio/video (A/V) input unit 120, a user input unit 130, a sensing unit 140, an output unit 150, a memory 160, an interface 170, a controller 180, and a power supply 190. The components shown in FIG. 1 are not essential parts and/or a number of components included in the mobile terminal 100 may vary.

Components of the mobile terminal 100 may now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114, and a location information module 115.

The broadcasting receiving module 111 may receive broadcasting signals and/or broadcasting related information from an external broadcasting management server through a broadcasting channel.

The broadcasting channel may include a satellite channel and a terrestrial channel. The broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal.

The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160.

The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 may correspond to a module for short range communication. Further, Bluetooth®, radio frequency identification (RFID), infrared data association (IrDA), ultra wideband (UWB) and/or ZigBee® may be used as a short range communication technique.

The location information module 115 may confirm or obtain a location or a position of the mobile terminal 100.

A global positioning system (GPS) module is a representative example of the location information module 115. The GPS module 115 may calculate information on distances between one point or object and at least three satellites and information on a time when distance information is measured and apply trigonometry to the obtained distance information to obtain three-dimensional position information on the point or object according to latitude, longitude and altitude at a predetermined time. A method of calculating position and time information using three satellites and correcting the calculated position and time information using another satellite may also be used. Additionally, the GPS module 115 may continuously calculate a current position in real time and calculate velocity information using the location or position information.

Referring to FIG. 1, the A/V input unit 120 may input (or receive) an audio signal and/or a video signal. The A/V input unit 120 may include a camera 121 and a microphone 122. The camera 121 may process image frames of still images or moving images obtained by an image sensor in a video telephony mode or a photographing mode. The processed image frames may be displayed on a display 151.

The image frames processed by the camera 121 may be stored in the memory 160 or may be transmitted to an external device through the wireless communication unit 110. The mobile terminal 100 may also include at least two cameras 121.

The microphone 122 may receive an external audio signal in a call mode, a recording mode and/or a speech recognition mode, and the microphone 122 may process the received audio signal into electric audio data. The audio data may then be converted into a form that can be transmitted to a mobile communication base station through the mobile communication module 112 and output in the call mode. The microphone 122 may employ various noise canceling algorithms for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 may generate a sensing signal for controlling operation of the mobile terminal 100. For example, in an example of a slide phone, the sensing unit 140 may sense whether the slide phone is opened or closed. Further, the sensing unit 140 may sense whether the power supply 190 supplies power and/or whether the interface 170 is connected to an external device. The sensing unit 140 may also include a proximity sensor 141.

The output unit 150 may generate visual, auditory and/or tactile output, and the output unit 150 may include the display 151, an audio output module 152, an alarm 153 and a haptic module 154.

The display 151 may display information processed by the mobile terminal 100. The display 151 may display a user interface (UI) and/or a graphic user interface (GUI) related to a telephone call when the mobile terminal 100 is in the call mode. The display 151 may also display a captured and/or received image, a UI or a GUI when the mobile terminal 100 is in the video telephony mode or the photographing mode.

The display 151 may include at least one of a liquid crystal display, a thin film transistor liquid crystal display, an organic light-emitting diode display, a flexible display and/or a three-dimensional display.

The display 151 may be of a transparent type or a light transmissive type. The transparent display may be a transparent liquid crystal display. A rear structure of the display 151 may also be of a light transmissive type. Accordingly, a user may see an object located behind the body of the mobile terminal 100 through the transparent area of the body of the mobile terminal 100 that is occupied by the display 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and/or a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display 151.

Referring to FIG. 1, the proximity sensor 141 (of the sensing unit 140) may be located in an internal region of the mobile terminal 100, surrounded by the touch screen, and/or near the touch screen. The proximity sensor 141 may sense an object approaching a predetermined sensing face or an object located near the proximity sensor 141 using an electromagnetic force or infrared rays without having mechanical contact. The proximity sensor 141 may have a lifetime longer than a contact sensor and may thus have a wide application in the mobile terminal 100.

The proximity sensor 141 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor.

A capacitive touch screen may be constructed such that proximity of a pointer is detected through a variation in an electric field according to the proximity of the pointer. The touchscreen (touch sensor) may be classified as a proximity sensor 141.

For ease of explanation, an action of the pointer approaching the touchscreen without actually touching the touch screen may be referred to as “proximity touch” and an action of bringing the pointer into contact with the touch screen may be referred to as “contact touch”. The proximity touch point of the pointer on the touchscreen may correspond to a point of the touchscreen at which the pointer is perpendicular to the touchscreen.

The proximity sensor 141 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touchscreen.

The audio output module 152 may output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm 153 may output a signal for indicating generation of an event of the mobile terminal 100. For example, an alarm may be generated when receiving a call signal, receiving a message, inputting a key signal, and/or inputting a touch. The alarm 153 may also output signals in forms different from video signals or audio signals, for example, a signal for indicating generation of an event through vibration. The video signals and/or the audio signals may also be output through the display 151 or the audio output module 152.

The haptic module 154 may generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operations of the controller 180 and/or temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 may control overall operations of the mobile terminal 100. For example, the controller 180 may perform control and processing for voice communication, data communication and/or video telephony. The controller 180 may also include a multimedia module 181 for playing multimedia. The multimedia module 181 may be included in the controller 180 or may be separated from the controller 180.

The controller 180 may perform a pattern recognition process capable of recognizing handwriting input or picture-drawing input applied to the touch screen as characters or images.

The power supply 190 may receive external power and internal power and provide power required for operations of the components of the mobile terminal 100 under control of the controller 180.

Various embodiments described herein may be implemented in a computer or similar device readable recording medium using software, hardware or a combination thereof.

According to hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to software implementation, embodiments such as procedures or functions may be implemented with a separate software module that executes at least one function or operation. Software codes may be implemented according to a software application written in an appropriate software language. The software codes may be stored in the memory 160 and executed by the controller 180.

Embodiments of the present invention will now be described.

It is assumed that the display 151 is a touchscreen for ease of understanding. As described above, the touchscreen 151 can execute both an information display function and an information input function. However, the present invention is not limited thereto. Touch mentioned in the specification may include both contact touch and proximity touch.

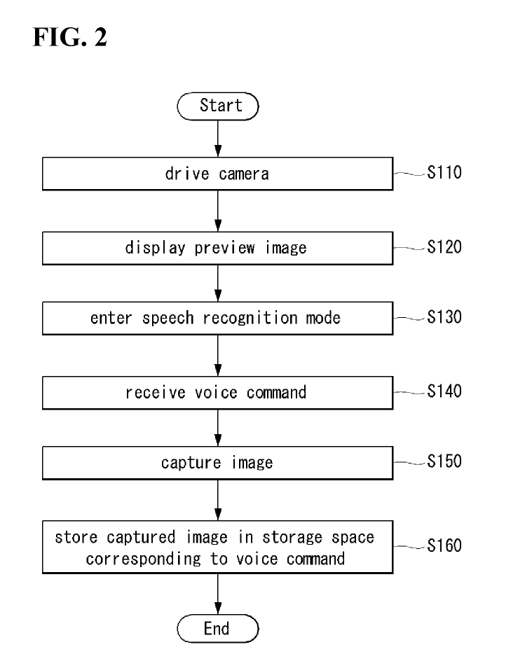

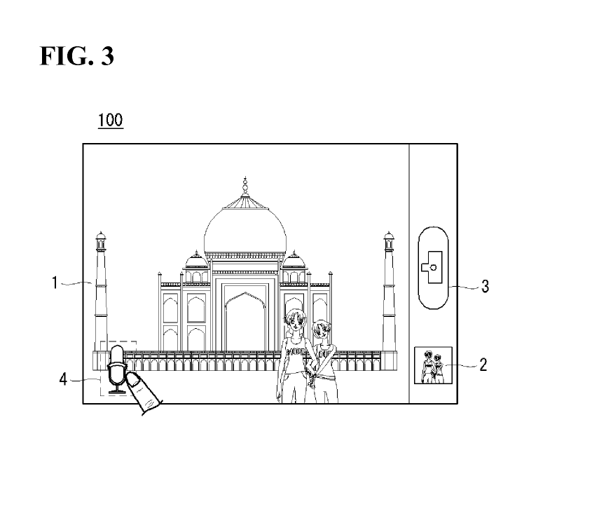

FIG. 2 is a flowchart illustrating a method of controlling a mobile terminal according to a first embodiment of the present invention and FIGS. 3 to 10 are views illustrating the method of controlling a mobile terminal according to the first embodiment of the present invention.

The method of controlling a mobile terminal according to the first embodiment of the present invention may be implemented in the mobile terminal 100 described above with reference to FIG. 1. The method of controlling a mobile terminal according to the first embodiment of the invention and operations of the mobile terminal 100 to implement the control method will now be described in detail with reference to the attached drawings.

Referring to FIG. 2, the controller 180 may drive the camera (121 of FIG. 1) (S110) and display a preview image input through the camera 121 on the touchscreen 151 (S120).

The controller 180 may enter a speech recognition mode upon reception of a predetermined input while the preview image is displayed on the touchscreen 151 (S130). That is, the controller 180 enters the speech recognition mode for recognizing a speech command of the user while a camera application is executed. In the speech recognition mode, the microphone (122 of FIG. 1) is enabled and a voice command of the user is received through the microphone (122 of FIG. 1).

Upon reception of the voice command, the controller 180 may capture an image corresponding to the preview image (S150) and, simultaneously, store the captured image in a storage space corresponding to the voice command (S160).

FIG. 3 shows display of a preview image 1 input through the camera on the touchscreen 151 upon execution of the camera application.

Referring to FIG. 3, the controller 180 may display a control area CA for controlling image capture on the touchscreen 151 in addition to the preview image 1. The control area CA may include a soft key 3 for capturing an image and a thumbnail image 2 of a recently captured image. According to an embodiment of the present invention, the controller 180 may display an icon 4 used to enter the speech recognition mode on the preview image 1 while the preview image 1 is displayed. The controller 180 may enter the speech recognition mode for recognizing a voice command input from the outside while the preview image 1 is displayed on the touchscreen 151 upon reception of a touch input applied to the icon 4.

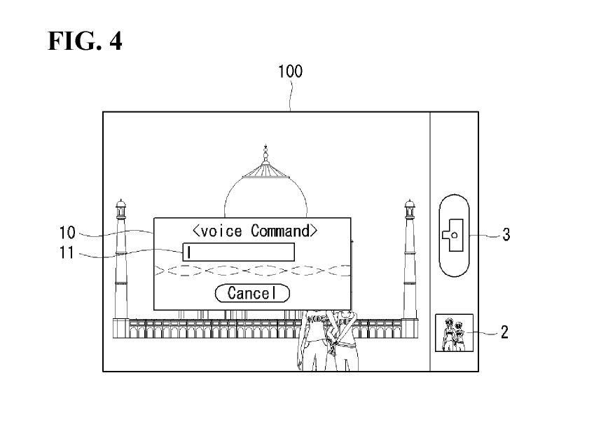

FIG. 4 shows an exemplary screen displayed when the mobile terminal 100 enters the speech recognition mode while the preview image is displayed.

Referring to FIG. 4, the controller 180 may display a user interface 10 for receiving a voice command of the user in the speech recognition mode on the preview image 1. The user interface 10 may recognize a voice command of the user in real time, convert the voice command into text and display the text in an area 11 of the screen of the user interface 10.

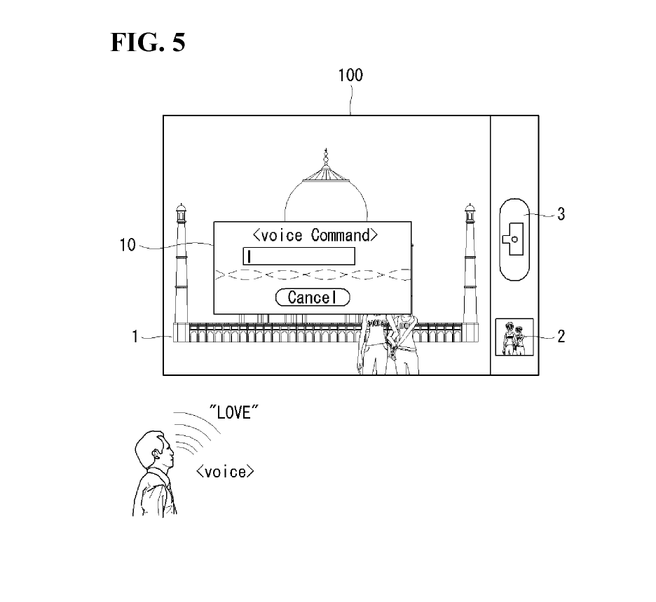

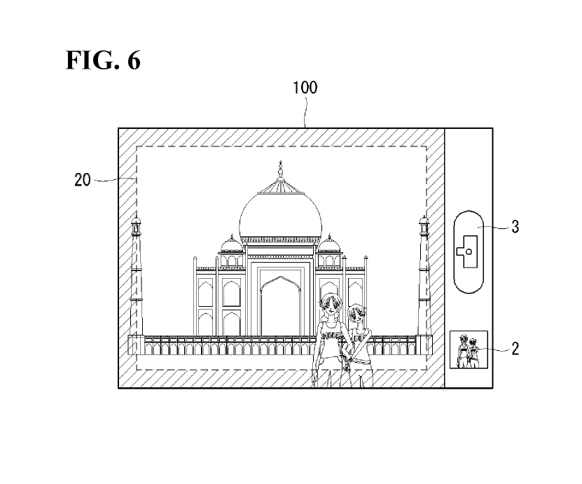

FIGS. 5 and 6 illustrate an example of receiving a predetermined voice command in the speech recognition mode.

Referring to FIGS. 5 and 6, upon reception of a predetermined voice command while the preview image 1 is displayed on the touchscreen 151, the controller 180 analyzes the voice command and captures an image 20 corresponding to the preview image 1 when the received voice command corresponds to a prestored voice command.

The controller 180 may display the captured image 20 on the touchscreen 151 for a predetermined time. In addition, the controller 180 may display a thumbnail image of the captured image 20 in the control area CA.

The controller 180 may store the captured image 20 in a storage space corresponding to the received voice command. The storage space may be previously set by the user.

The storage space corresponding to the voice command may be the memory (160 of FIG. 1) of the mobile terminal 100. The storage space may include a folder in which a predetermined image is stored.

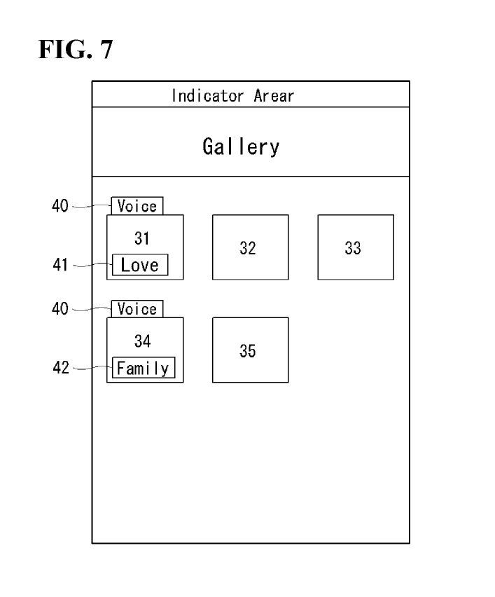

For example, the controller 180 can store images captured by the camera in a plurality of folders 31, 32, 33, 34 and 35, as shown in FIG. 7. The plurality of folders 31, 32, 33, 34 and 35 may be classified according to predetermined standards by the user. Furthermore, the plurality of folders 31, 32, 33, 34 and 35 may be divided into a folder storing an image captured by the voice command and other folders.

For example, the folders 31 and 34 can be folders for storing images captured by a voice command. An indicator 40 for indicating that the folders relate to a voice command may be tagged to the folders 31 and 34.

The folder 31 may correspond to a voice command “Love” and the folder 34 may correspond to a voice command “Family”. That is, upon recognition of the voice command “Love” input by the user, the controller 180 captures an image and, simultaneously, stores the captured image in the folder 31. Upon recognition of the voice command “Family” input by the user, the controller 180 captures an image and, simultaneously, stores the captured image in the folder 34.

That is, according to the first embodiment of the present invention, it is not necessary to select the soft key (3 of FIG. 3) for capturing an image when a predetermined voice command is received. Furthermore, an additional process for storing the captured image in a specific folder is not needed. That is, it is possible to capture an image according to one voice command and, simultaneously, store the captured image in a storage space corresponding to the voice command.

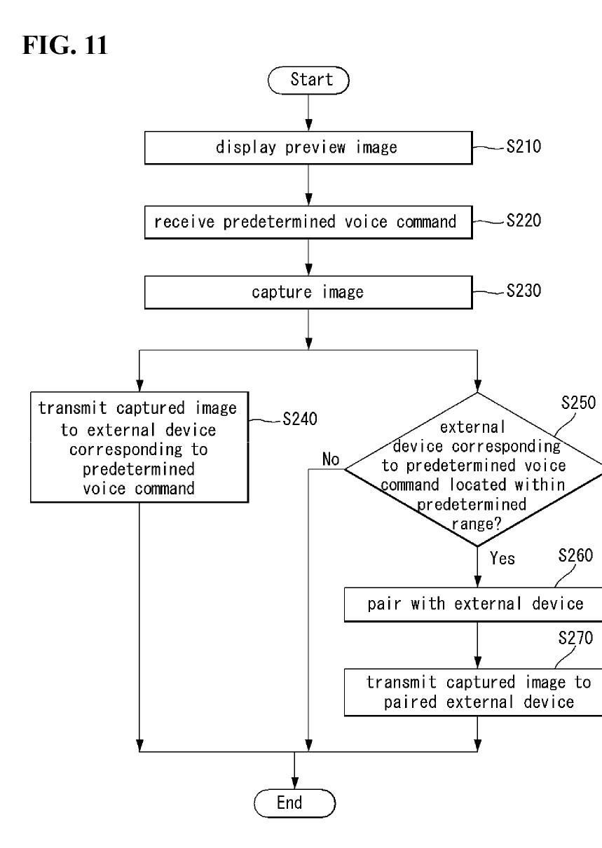

The storage space may be an external device of the mobile terminal 100. An embodiment of capturing an image through the predetermined voice command and transmitting the captured image to at least one external device will be described in detail later with reference to FIG. 11.

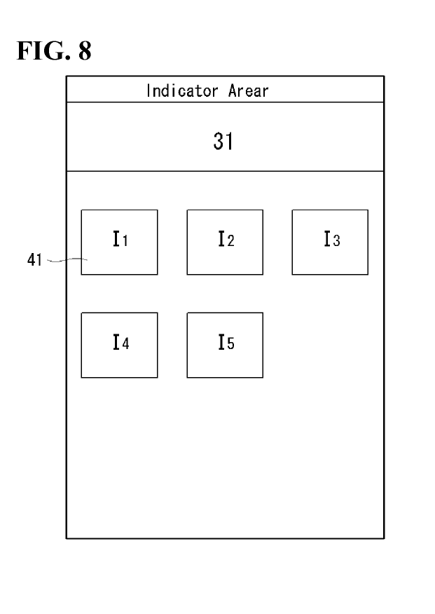

FIG. 8 shows an exemplary screen displaying a result obtained by capturing images according to the voice command “Love” in FIG. 5 and storing the captured images in the folder 31. The plurality of images I1, I2, I3, I4 and I5 shown in FIG. 8 are images captured upon reception of the voice command “Love”.

Images stored in the folder 34 shown in FIG. 7 are images captured upon reception of the voice command “Family”.

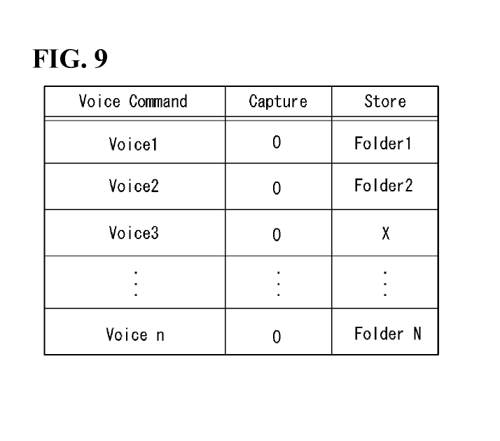

The memory (160 of FIG. 1) of the mobile terminal 100 according to an embodiment of the present invention may store a table in which a plurality of functions corresponding to specific voice commands is set. Referring to FIG. 9, for example, a first voice command Voice1 corresponds to a function of capturing an image and storing the captured image in folder 1 and a second voice command Voice2 corresponds to a function of capturing an image and storing the captured image in folder 2. A third voice command Voice3 corresponds to a function of capturing an image only. In this manner, the function of capturing an image and the function of storing a captured image may be previously set to the plurality of voice commands.

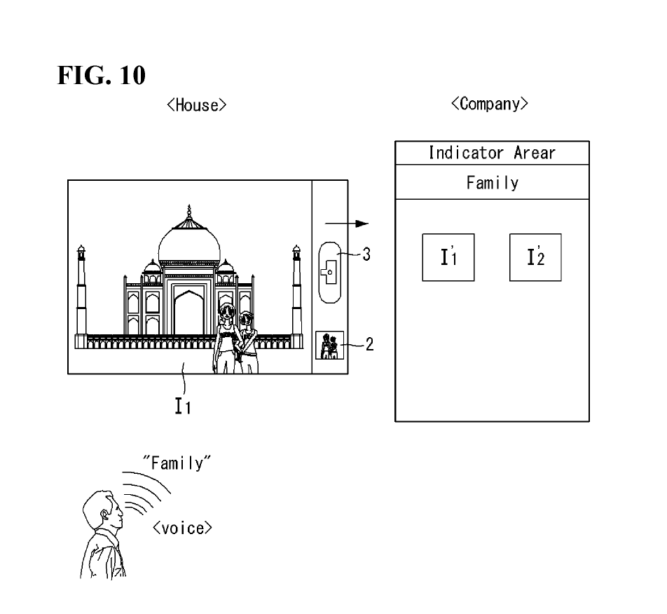

Although the plurality of voice commands can be predetermined, the user may have difficulty correctly remembering the predetermined voice commands. Referring to FIG. 10, for example, when a predetermined voice command is “Family” in English and a voice command “Family” in Korean is input by the user, the controller 180 may recognize the meaning of the voice command “Family” and execute the function of capturing an image and storing the captured image, which corresponds to the predetermined voice command “Family”.

That is, when a first voice command received in the speech recognition mode has the same meaning as a predetermined second voice command although the first voice command and the second voice command are not equal to each other, the controller 180 can execute a function corresponding to the predetermined second voice command.

When a voice command received in the speech recognition mode does not correspond to a predetermined voice command, the controller 180 may display a user interface for setting a storage space corresponding to the received voice command on the touchscreen 151. For example, when a voice command input by the user is not stored in the memory (160 of FIG. 1), the controller 180 can display menu items (not shown) for setting a function corresponding to the new voice command on the touchscreen 151. The menu items may include the function of capturing an image corresponding to a preview image, the function of designating a storage space storing the captured image, etc., as described above.

The embodiment of capturing an image corresponding to a preview image while the preview image is displayed upon reception of a predetermined voice command and, simultaneously, storing the captured image in a storage space corresponding to the voice command has been described. The storage space may be a storage space previously set in the mobile terminal 100 or may include an external device.

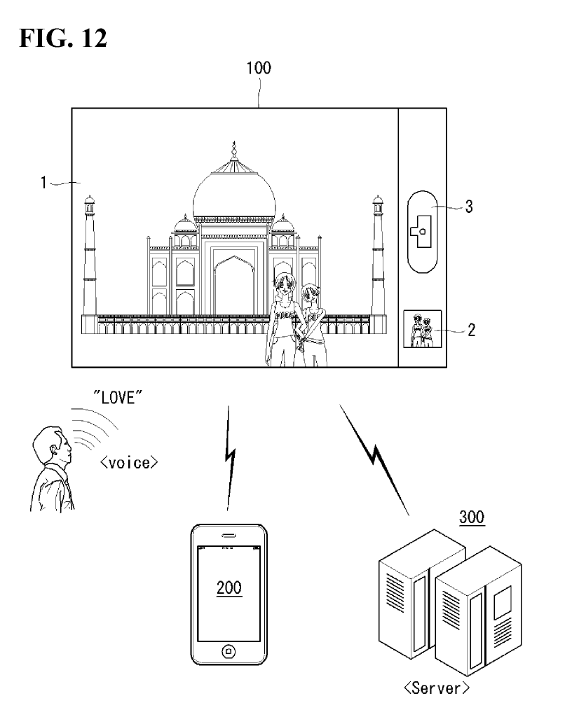

FIG. 11 is a flowchart illustrating a method of controlling a mobile terminal according to a second embodiment of the present invention and FIGS. 12, 13 and 14 are views for explaining the method of controlling a mobile terminal according to the second embodiment of the present invention.

The method of controlling a mobile terminal according to the second embodiment of the present invention may be implemented in the mobile terminal 100 described above with reference to FIG. 1. The method of controlling a mobile terminal according to the second embodiment of the invention and operations of the mobile terminal 100 to implement the control method will now be described in detail with reference to the attached drawings.

Referring to FIG. 11, the controller 180 may drive the camera and display a preview image input through the camera on the touchscreen 151 (S210). Upon reception of a predetermined voice command input by the user (S220), the controller 180 captures an image corresponding to the preview image (S230).

The controller 180 may transmit the captured image to an external device corresponding to the predetermined voice command (S240).

For example, the controller 180 can capture the image corresponding to the preview image according to the predetermined voice command and transmit the captured image to the external device corresponding to the voice command through the wireless communication unit (110 shown in FIG. 1).

The captured image may be transmitted to the external device corresponding to the voice command using a phone number, e-mail address, etc. corresponding to the external device, previously set by the user. For example, when the predetermined voice command is “Family”, the controller 180 can capture the image corresponding to the preview image and transmit the captured image to all family members. The controller 180 may previously set phone numbers of the family members corresponding to the voice command “Family”.

FIG. 12 shows an example of transmitting a captured image to an external device according to the second embodiment of the invention. Referring to FIG. 12, the controller 180 may capture an image upon reception of a predetermined voice command and transmit the captured image to an external device 200 and/or an external server 300 corresponding to the predetermined voice command. The external device 200 may include a mobile terminal and the external server 300 may include an e-mail server and a social network management server. The social network management server may include servers providing social network services, such as Twitter, Facebook, etc.

Referring back to FIG. 11, the controller 180 may share the captured image with at least one external device.

For example, the controller 180 can determine whether at least one external device corresponding to the predetermined voice command is located within a predetermined range (S250).

The mobile terminal 100 according to an embodiment of the present invention may perform short-range communication with the at least one external device corresponding to the voice command. For example, the controller 180 can be connected to the at least one external terminal through Bluetooth (S260).

That is, upon reception of the predetermined voice command, the controller 180 can determine whether at least one external device corresponding to the voice command is located near the mobile terminal 100 and, when at least one external device is located nearby, transmit a control signal for performing pairing with the external device to the external device.

Upon connection of the mobile terminal 100 with the at least one external device, the captured image can be transmitted to the at least one external device (S270).

The method of sharing a captured image with at least one external device is not limited to the above-described example. The external device may be a server providing a social network service, for example. In this case, the mobile terminal 100 can drive the camera, capture an image corresponding to a preview image upon reception of a voice command “Facebook” from the user while the preview image is displayed on the touchscreen 151, and automatically upload the captured image to “Facebook”.

According to the first embodiment of the present invention, the function of capturing an image and the function of storing the captured image in a predetermined storage space can be simultaneously performed according to one voice command while a preview image is displayed on the touchscreen during execution of the camera application.

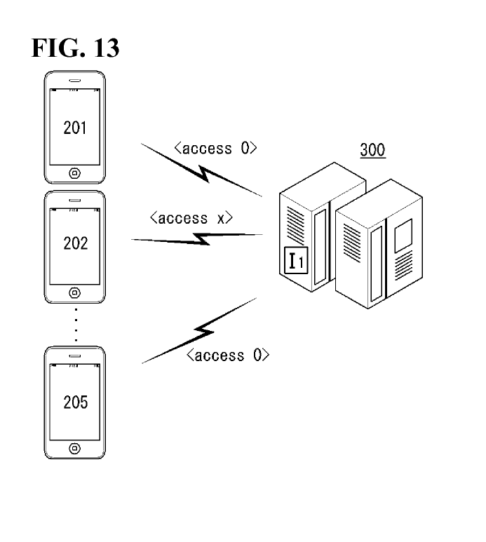

Referring to FIG. 13, it is possible to set external devices 201 to 205 capable of accessing the captured image through the server 300 while storing the image captured through the voice command in the server 300 according to the second embodiment. For example, the mobile terminal 100 may allow the first external device 201 to access the captured image and may not permit the second external device 202 to access the captured image while storing the image captured through the voice command in the server 300. A user interface (not shown) for setting external devices capable of accessing the server 300 may be displayed on the touchscreen 151 such that the user can select external devices capable of accessing the server 300 through the user interface.

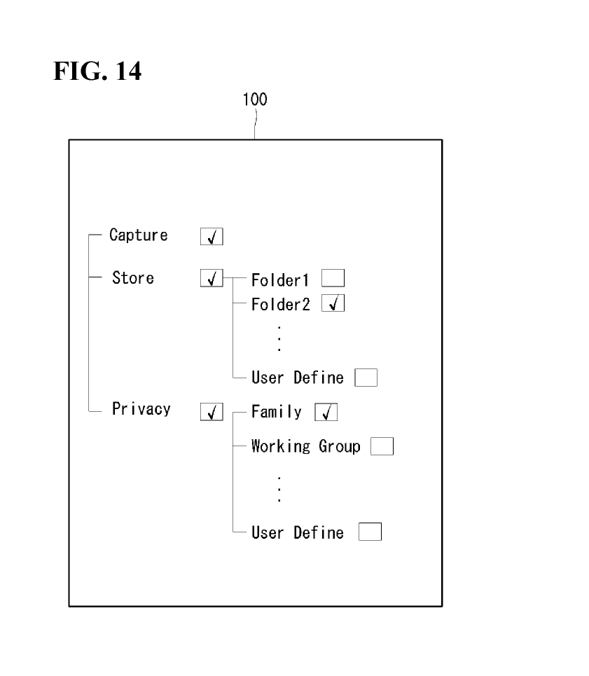

FIG. 14 illustrates exemplary functions that can be set according to an input voice command according to an embodiment of the present invention.

Referring to FIG. 14, the function of capturing an image, the function of storing the image captured by the capturing function in a second folder Folder2, and a function of limiting the access level of information to family correspond to a first voice command Voice1. However, functions set to the first voice command are not limited thereto.

For example, the access level of information can be set by the user in such a manner that a captured image is opened only to people belonging to a specific group or to people selected by the user.

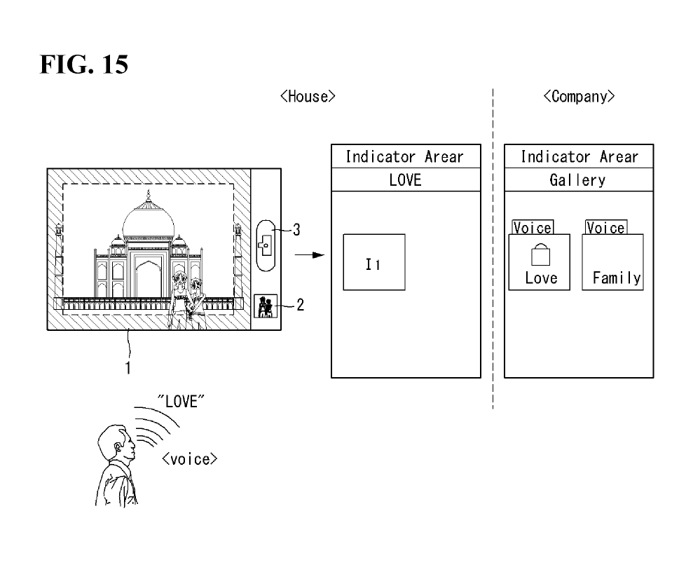

FIG. 15 illustrates an embodiment of tagging location information to a captured image according to voice command type.

Referring to FIG. 15, the mobile terminal 100 according to an embodiment of the present invention may further include the location information module (115 of FIG. 1). The controller 180 of the mobile terminal 100 may store, through the location information module (115 of FIG. 1), location information of the mobile terminal 100 when an image is captured through a predetermined voice command according to the above-described embodiment of the invention.

The controller 180 may tag the location information of the captured image.

In addition, the controller 180 may determine the access level of information depending on the location of a folder in which a captured image is stored. For example, when the mobile terminal 100 is located at a home of the user and the user inputs the voice command “Love” while a preview image is displayed according to the camera, the controller 180 captures an image corresponding to the preview image and stores the captured image I in a folder “Love”. Then, when the mobile terminal 100 is moved from a predetermined location “Home” or located in a predetermined location “company”, the controller 180 may set a password for the folder “Love” and lock the folder “Love”.

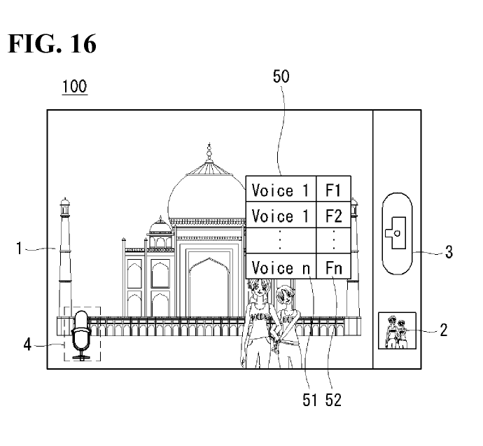

FIG. 16 illustrates an exemplary operation of providing types of voice commands used to capture an image.

Referring to FIG. 16, when the preview image 1 is displayed on the touchscreen 151 and the icon 4 used to select the speech recognition mode is selected, the controller 180 may display a list 50 of voice command candidates that can be input in the speech recognition mode and execute predetermined functions on the touchscreen 151. For example, the voice command candidate list 50 can include information about types 51 of voice commands that can be input and spaces in which images captured through the voice commands will be stored.

According to the above-described embodiments of the present invention, it is possible to capture images through a voice command, classify the captured images and store the classified images, simultaneously. Furthermore, it is possible to set the access level of a storage space storing a captured image according to voice command type. Accordingly, predetermined content can be easily shared through the camera of the mobile terminal 100 and privacy can be easily set.

The above-described method of controlling a mobile terminal may be written as computer programs and may be implemented in digital microprocessors that execute the programs using a computer readable recording medium.

The method of controlling a mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

The mobile terminal and control method thereof according to an embodiment of the present invention have the following advantages.

It is possible to capture an image and efficiently manage the captured image through a voice command.

Furthermore, an additional process for classifying captured images is not needed, and image capture and automatic storage of a captured image in a storage space can be simultaneously performed through a single voice command.

What is claimed is:

1. A mobile terminal, comprising:
a camera;
a touchscreen;
a speech recognition module; and
a controller configured to display a preview image input through the camera on the touchscreen, to capture an image corresponding to the preview image in response to a predetermined voice command upon reception of the predetermined voice command through the speech recognition module in a speech recognition mode, and to store the captured image in a storage space corresponding to the voice command.

2. The mobile terminal of claim 1, wherein the controller enters the speech recognition mode when a predetermined input is received while the preview image is displayed on the touchscreen.

3. The mobile terminal of claim 1, further comprising a memory configured to map voice command types to storage spaces in which captured images will be classified and stored and to store the captured image in a corresponding storage space.

4. The mobile terminal of claim 3, wherein the controller analyzes the meaning of a second voice command when the second voice command similar to a first voice command stored in the memory and, when the second voice command has the same meaning as the first voice command, stores the captured image in a storage space corresponding to the first voice command.

5. The mobile terminal of claim 1, further comprising a wireless communication unit, wherein the controller transmits an image captured according to a predetermined voice command to at least one external device through the wireless communication unit.

6. The mobile terminal of claim 1, further comprising a short range communication module, wherein the controller transmits a control signal for pairing with at least one external device corresponding to the predetermined voice command to the at least one external device and sends the captured image to the paired external device upon pairing with the at least one external device.

7. The mobile terminal of claim 1, wherein the controller displays, on the touchscreen, a list including a capture function and at least one voice command for storing a captured image in a predetermined storage space.

8. The mobile terminal of claim 1, further comprising a location information module, wherein the controller acquires location information of the mobile terminal through the location information module and sets a security level for access of the storage space depending on the location information of the mobile terminal.

9. The mobile terminal of claim 1, wherein the controller displays a user interface for setting a storage space corresponding to the received voice command on the touchscreen when the voice command received in the speech recognition mode is not a predetermined voice command.

10. A method of controlling a mobile terminal, comprising:
displaying a preview image input through a camera on a touchscreen;
entering a speech recognition mode while the preview image is displayed on the touchscreen;
receiving a predetermined voice command through a speech recognition module;
capturing an image corresponding to the preview image in response to the received voice command; and
storing the captured image in a storage space corresponding to the voice command.

11. The method of claim 10, wherein the displaying of the preview image on the touchscreen comprises displaying an item for enabling the speech recognition module along with the preview image on the touchscreen and entering the speech recognition mode upon reception of a touch input for selecting the item.

12. The method of claim 10, further comprising mapping voice command types to storage spaces in which captured images will be classified and stored and storing the captured image in a corresponding storage space.

13. The method of claim 10, further comprising transmitting the image captured according to the predetermined voice command to at least one external device through a wireless communication unit.
